(19) United States
(12) Patent Application Publication
(10) Pub. No.: US 2009/0123247 A1
(43) Pub. Date: May 14, 2009

(54) Ultra high pressure machining spindle

(76) Inventor: Joseph Richard Clark, Howardstown, KY (US)

Correspondence Address: Joseph R. Clark, 900 Spalding Hollow Rd, Howardstown, KY, 40251-6548, US

(21) Appl. No.: 11/983,389

(22) Filed: Nov. 9, 2007

(51) Int. Cl. B23C 1/00

(52) U.S. Cl. 409/231

(57) ABSTRACT

A system and technique wherein an ultra high-pressure (UHP) stream of water passing through a calibrated orifice achieves high water velocity. The orifice would be made from an extremely hard material such as sapphire or diamond. This high velocity stream impacts on a driving fluid turbine impeller attached to a shaft forming an opposed high-speed tool, which results in very high rotational speed with very high available power to do work. Off/On Control of the system would be accomplished through an integrated ultra high-pressure valve system.

### BACKGROUND OF INVENTION

Conventional Machine Tools use rotating element spindles that hold a high-speed cutting tool. Typically rotational speed results from using lightweight ceramic bearings with an oil mist lubrication system. Typical speeds achieved are limited to 18,000 to 30,000 rpm. In order to hold the tool with sufficient stiffness, the minimum diameter and length of the spindle is usually several times the diameter of the tool or tool holder. The spindle rotates in rotating element bearings which gives it radial and axial load capacity and is typically powered with an electric motor and in some cases an air motor. The size of the cutting tool significantly affects the speed and power capacity of the spindle. In general, the smaller the tool the greater the rpm of the spindle but the smaller the unit power output. This limits the metal removal rate and therefore the productivity of the spindle system.

As spindle rotational speeds and powers increase specifically as needed for machining and cutting composites, aluminum and titanium, as an example, the viscous drag on the bearings increases, which requires the use of bearing with fewer rolling members, or lighter rolling elements such as ceramic. This makes the spindle more subject to damage when the machine crashes into an object. This situation occurs most often at the high speeds machines of this type utilize in performing normal operation. Additionally or alternatively, it is common practice to decrease the preload on the rolling elements, which reduces the power consumed by the bearing. This results in decreasing the stiffness of the bearings resulting in greater tool displacement and additional cut error.

A fundamental issue is the need for a spindle shaft that is several times larger than that of the tool in order to rigidly hold the tool in the spindle. The penalty for using bearings of larger diameter is the high power losses and high heat generation since viscous power losses increase with the square of the bearing diameter and the number of rolling members. Increasing the speed on rolling element bearings past a DN value of 2 million (DN equals speed in rpm times diameter in millimeters) is a daunting task with very limited return on the investment for standard rolling element bearings. Driving spindles which have the capability greater than 50 kw containing integral motors does not improve the situation discouraging because the heat generation caused by motor inefficiencies results in substantial thermal errors. The cost of conventional high-speed high power rolling element spindles is very high and can very on the order of $30,000 to $100,000 depending on the size and energy output.

Currently, spindles supported by pressured air have been used to provide the capability to run at very high speeds. For an air bearing to be stable it requires a very small radial bearing gap. Even air, which has 1/10th the viscosity of water, can generate significant viscous drag power losses at very high speeds. In addition, air can only be used at very low pressures, on the order of 200 psi, so the load bearing capacity of high-speed air bearing spindles is much less than those of rolling element spindles. Because of the compressibility of air, these systems are very delicate and any impact load on the spindle results in a crash destroying the air bearings and the spindle.

Another type of prior spindle technology used for very high speeds involves magnetic bearings. Magnetic bearings can run with large 1 mm gap and thus generates no shear power losses. However, electromagnetic bearings offer no greater load-supporting capability than available air bearings which limits the stiffness that they can apply to the cutting tool. As with rolling element and air bearings, a magnetic bearing spindle that crashes at very high speed ultimately destroys itself due to the shaft energy.

Another type of bearing technology available involves the use of hydrostatic bearings. Due to power losses caused by viscous shearing these bearings are typically never run at speed values of DN greater than 500,000 when oil is used as the pressurizing fluid. Thus a 50 mm diameter oil-hydraulic spindle would never be run at more than 10,000 rpm. Though higher speeds can be obtained when water is used as the pressurizing fluid. Even water-pressurized hydrostatic bearings have substantial shearing power losses at high speed when large spindle diameters are used.

In order to maximize power density and increase tool rotation accuracy the present invention takes a different approach by incorporating the hydrostatic bearing into the surface of the spindle shaft, eliminating that rotating mass with its associated bearing assembly, eliminating the spindle electric rotor with its extended length and incorporating ultra high-pressure turbine for driving the shaft. When ultra high-pressure fluid, ranging from 30,000 to 60,000 psi, is applied to the system the fluid drives the turbine causing it to spin at very high angular velocity with very high available power for tool action (e.g. cutting, milling, grinding). The use of ultra high-pressure fluid decreases the fluid volume and the size of the spindle required to perform the work. The fluid also provides the capability for very high radial and axial hydrostatic bearing capacities and as an additional benefit improved chip removal by using high-pressure fluid through the tool assisting in chip removal.

As an example a 25 mm spindle shaft constructed in accordance with the invention and supplied with 3472 atm. of fluid pressure can potentially generate 35 Hp of power for cutting at 100,000 rpm. This is dependant on the orifice size and flow rate at the indicated pressure. The power losses in the system caused by the viscous fluid shearing would be about 5 Hp, thus the total power generated by the turbine would be about 30 Hp. This is about equal to the power losses of a conventional spindle running at only 30,000 rpm. This major advancement in power and speed can increase manufacturing productivity by an order of magnitude over current rolling element-bearing systems.

Current spindle technology couples a large diameter high power motor to a small tool shaft. This approach reduces the stiffness of the system and increase the overall power loss to the system. Eliminating the motor altogether and utilizing water hydrostatic bearings and driving the tool with a water-turbine increase the stiffness of the system. The mass transported is decreased with the response of the total system improved. Water turbines can provide much higher power densities than electric motors since that very high power is directly available for machining. This power results in low temperature rises since the water pressure is high (in the thousands of atmospheres) along with very high bearing load capacity.

### BRIEF SUMMARY OF THE INVENTION

In summary, the invention, involves a cutting system containing spindle shaft with replaceable tools. The shaft would have integrated into it water hydrostatic bearing pockets. The shaft would contain provisions for the mounting of or integral a radial water turbine capable of accepting Ultra High-Pressure fluid namely water.

The invention is concerned with a spindle shaft that is supported in a bore by water hydrostatic bearings that act directly on the shaft so that the shaft itself is the spinning element and coupled to the shaft is a water turbine providing power to spin the shaft to perform work, such as cutting or milling as in a machine tool. The spindle upper housing contains a means of water in-feed to reduce the size of the stream through an orifice to a point in which the stream achieves an extreme high velocity. The upper housing would contain a means of controlling the ultra high pressure stream of water off and on allowing start and stop of spindle rotation. The housing would contain an out feed for pressurized discharge of the fluid from the water turbine. The discharged fluid may serve as the media for the hydrostatic bearing providing rotation and stiffness for the system. The bore would contain a feedhole allowing high-pressure water to pass axially through the spindle shaft to the tool assisting in chip removal.

### BRIEF DESCRIPTION OF DRAWING VIEW AND FIGURES

The invention will now be described with reference to the accompanying drawings in which:

FIG. 1 shows a cross section of the radial flow spindle system. This section shows the arrangement of hydrostatic bearings including inlet and outlet ports, the inlet port for Ultra high pressure water for the cutting tool, the method of sealing the upper and lower housing, the water turbine area, and the means of removing the cutting tool

FIG. 2 shows a cross section through the ultra high pressure control system input. This section shows the arrangement of the off-on control valve and the means of sealing the Ultra high pressure valve zone.

FIG. 3 shows a cross section through the entrance to the water turbine. This section shows the inlet orifice jewel assembly and turbine blades.

FIG. 4 is a plot of the turbine power as a function of speed.

FIG. 5 is a plot of the maximum turbine output as a function of speed.

FIG. 6 shows a typical system, which would utilize the spindle as a cutting means. The figure shows a gantry style machine with control panel and pump. The spindle is mounted on the Z axis. No worktable is shown.

FIG. 7 shows top view of rear housing. This figure shows the Ultra high-pressure tubing entrance (item 34), turbine discharge drain (item 40).

### DETAILED DESCRIPTION OF THE INVENTION

In order for developed societies to compete in manufacturing they must have more advanced tool that can enable their higher paid machinists the ability to produce parts faster than lower paid machinists. This can be accomplished in many ways using automation. It is noted that the cost of automation can offset the increase in productivity. A better approach would be to increase the metal removal rate and thereby reduce the time to produce the same part. This is especially true when cutting parts that require a long time on the machine such as aircraft parts or the like, the answer is a several order of magnitude increase in the metal removal rates. This results from the use of higher spindle speeds which provide this performance increase over that of conventional machines. (This is generally what lower cost producers generally have available to them.)

The critical goal, therefore, for manufacturers is to be able to obtain very high speed for tools, using an economical and robust system. Existing designs for ceramic ball bearing or magnetic bearing high-speed spindles are very expensive and very delicate, and thus do not provide what is really needed. This invention in incorporating water hydrostatic bearings and a ultra high pressure water turbine yields a very robust high speed system in which the unit mounted on the machine tool is actually fairly inexpensive. As a result if there is a crash, little damage is done to the spindle.

To minimize cost and heat generated by a spindle, the hydrostatic bearings are made part of the spindle shaft. The problem of how to get rotational power to the tool is solved through driving of the tool with turbine blades. The turbine section is integral to the spindle shaft reducing the cost of producing multiple parts. This eliminates the need for a very costly high-speed motor and the associated precision bearings and drive electronics. If the spindle used in this art is crashed it will not destroy any expensive motor or bearing components.

The generic solution provided by the invention addresses these goals by providing a spindle wherein the cutting tool is supported in a bore by hydrostatic bearings that act directly on the spindle shaft so that the shaft itself is the spinning element and by providing power through an integral or modular radial water turbine to spin the tool so that it can do work, such as cutting in a machine tool.

Before referring to the drawings illustrating the construction of the invention, it is believed helpful to consider the physics of the system.

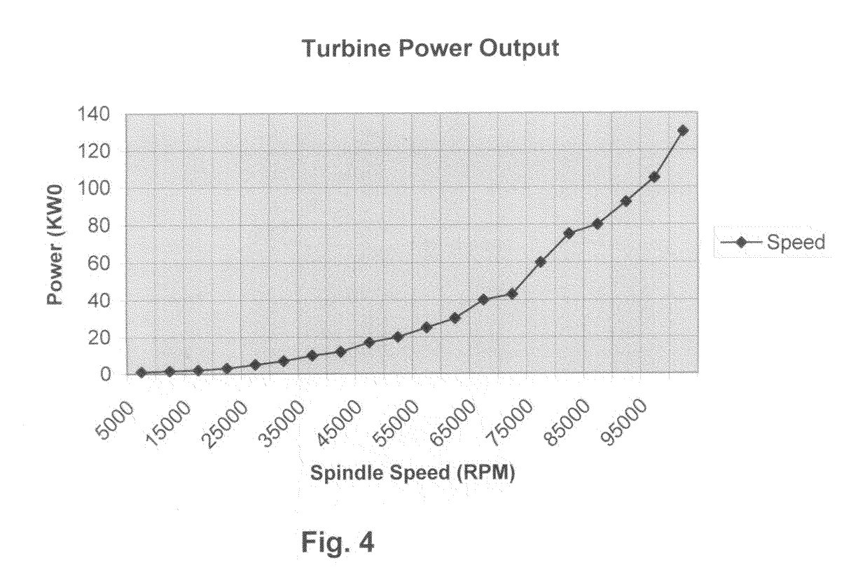

When machining aluminum a general rule is that one needs 1 kW of power for every 1000 rpm of a 25 mm diameter cutter. FIG. 4, as previously described is a plot of the turbine power as a function of speed. Note that turbines generate power based on a speed cubed law and thus as the speed goes up, the power generated becomes very high. At 100,000 rpm the no-loss power generated can be 140 kW that allows for 40 kW of losses and inefficiency. For the turbine covered by the invention the water pressure minimum is 2080 atm. (30,000 psi) and the flow rate minimum is 3 gpm.

If the radial and axial bearing operates of the discharge pressure of 3000 psi, then even a small 25 mm tool in the holder would be able to support 3000N, which as a radial load on the tool at 100,000 rpm represents 50 kW of power. Thus the bearings are well suited to support the bearing force and the design is well balanced.

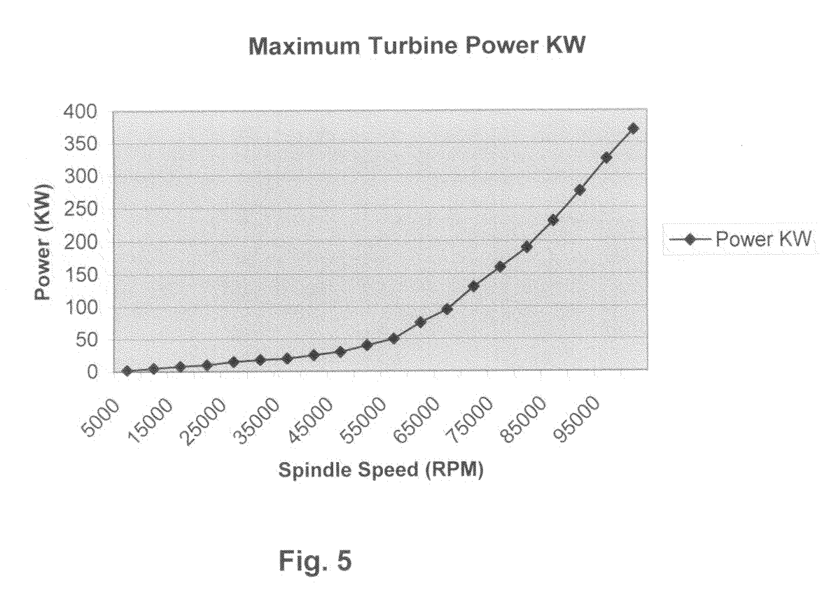

FIG. 5 as previously described, is a plot of maximum turbine power that can reasonably be obtained as a function of speed. As an example a 47 mm×40 mm radial flow turbine along with radial and axial hydrostatic bearings, at 100,000 rpm the power generated can be as much as 377 kW. Based on calculations utilizing a 30,000 psi capacity system with a flow rate of 3 gpm the system would have the capability of operating at 75000 rpm and have a power output of 40 kW. The correct orifice size for this system would be 0.020 inch and would be made from a sapphire.

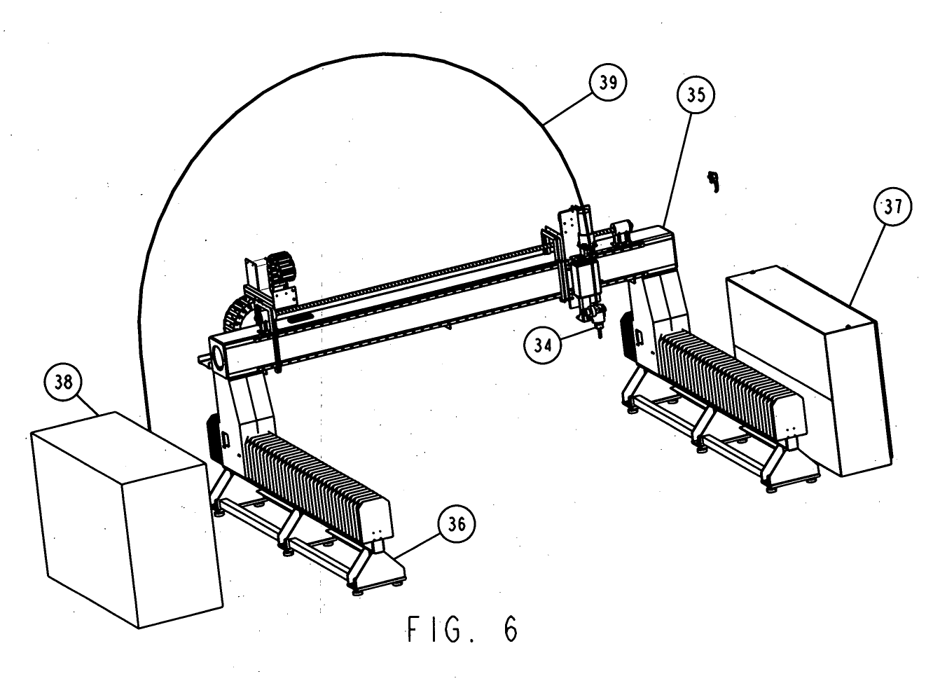

A preferred integrated system so designed is shown in FIG. 6. FIG. 6 is a machining center (item 35) is shown as a gantry style. This style has a stationary base on which a structure moves constituting the X-axis. The Y and Z-axis are contained on the bridge of the structure. The machine can be of other machine tool forms as well. A typical machine configuration would utilize an ultra high pressure spindle for purposes of cutting both the 2D and 3D configuration of the part. The Z axis would contain the Ultra high pressure spindle (item 34). A table (not shown) supports a part, which often will be as big as the table itself. For example sections for aircraft are hogged out of solid billets of aluminum to minimize weight and maximize strength. An ultra high pressure line extending from an intensifier (item 38) located off machine in the general area supplies water pressure and volume through a heavy wall plumbing system to the machine (item 39). An option the system may contain two plumbing lines, Ultra high pressure feed line (item 39) and a low pressure return line. The return water line will bring water back to the pressure supply-filter-cooling system.

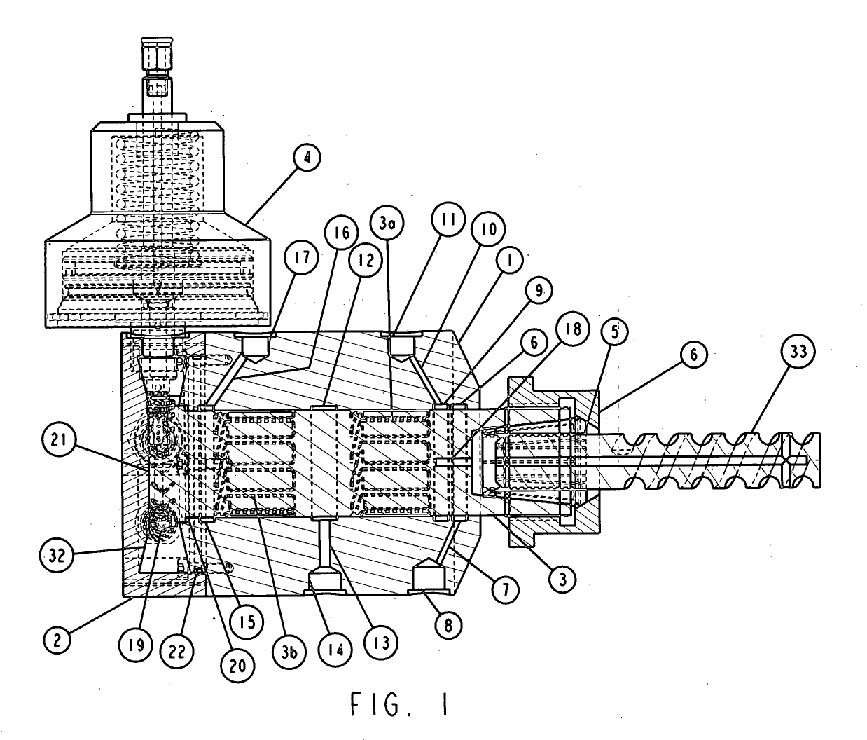

FIG. 1 shows a cross section of the radial flow section of the spindle. The replaceable tool 6 (item 33) is located in the front of the spindle-shaft (item 3) and held in position with a collet (item 5) and nut (item 6). The spindle shaft is located in a front housing (item 1) extending with its cutting end to the left beyond the tapered forward left-hand end of the bore and its rear end connected to the latter and carrying the turbine drive housing. Hydrostatic bearing features are formed directly into the spindle shaft forming radial groves bearings (items 3a and 3b). Construction of the hydrostatic pocket and bearing may be of the method as outlined in U.S. Pat. Nos. 2,449,297(Hoffer), 3,754,799(Hedberg), 4,351,574(Furukawa), 5,104,237(Slocum) and others. Ultra High-Pressure fluid to these bearings is supplied through a pressurized annulus (item 13), which is supplied through a high-pressure port (item 14). Fluid from the bearings drains through small annuli (items 9 and 15), which are connected to drain ports 10 and 16 through formed holes 11 and 17. This arrangement gives the spindle shaft high load capacity and is significantly more rigid than a standard rotating element bearing system.

Note that in high speed milling is not possible to provide jet assisted chip removal because there are no high-speed couplings available for through the tool delivery. Furthermore, the high-speed tool generates a powerful vortex around the working tool, which prevents an externally jetted stream to the cut area. To address this problem, high-pressure water can enter the tool through a radial hole (item 18) in line with the coolant feed annuli (item 6) and fed through port 7 from connection location 8. The jet stream would then travel axially along the spindle shaft through the collet (item 5) into the tool (item 33). The fluid would be ejected through ports in the body of the tool.

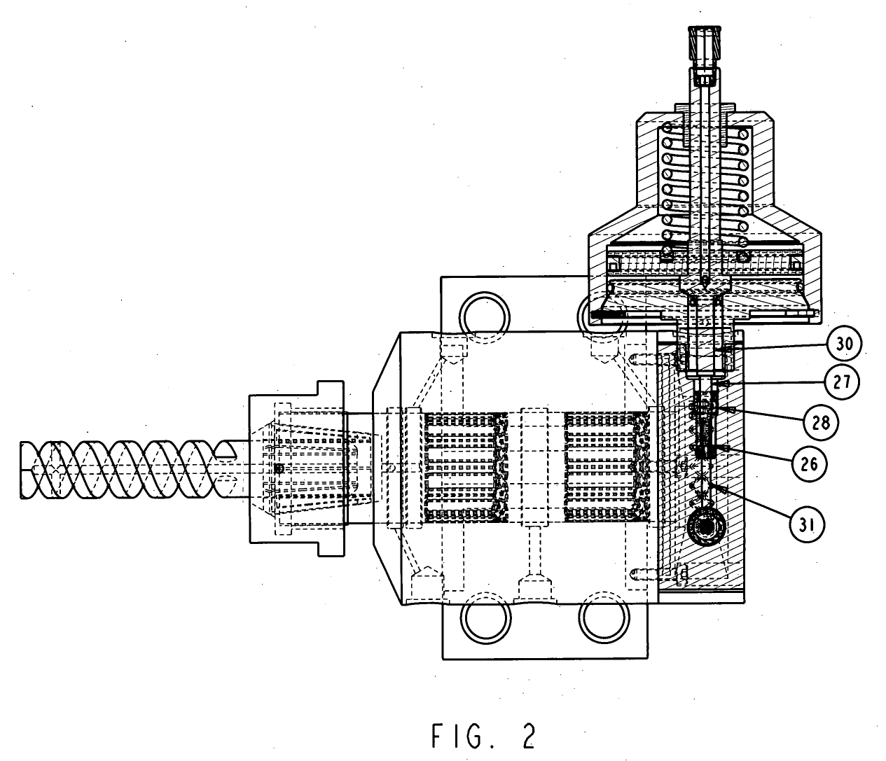

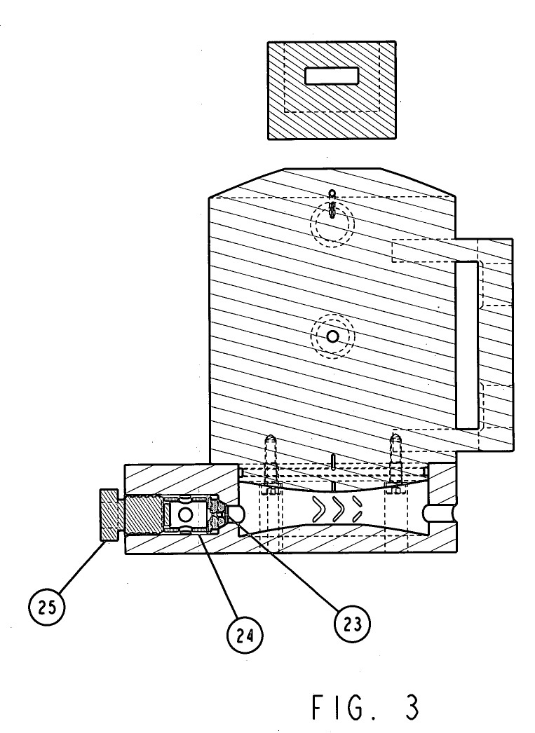

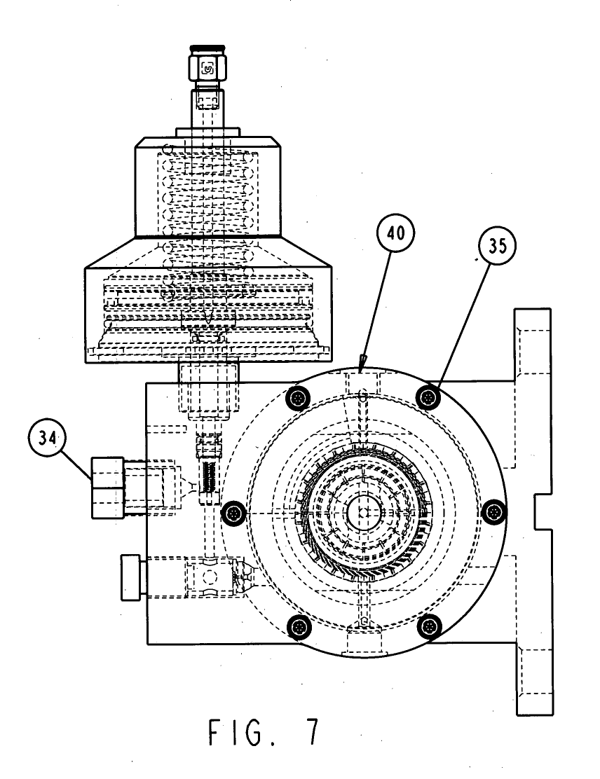

The radial turbine system is contained in the rear housing (item 2), which is seated to the front housing (item 1) and sealed with an o-ring system designed for ultra high-pressure operation. Bolts (item 35) shown in FIG. 7 and located in the rear housing clamp the system together. The ultra high pressure for the system enters normal to the upper housing through high-pressure port (item 34). The water proceeds through an Off/On valve port (item 31). Off/On spindle control is caused by applying air pressure to an actuator assembly (item 4), this retracts a poppet (item 27, FIG. 2) from the seat (item 26) allowing fluid to enter the columniations chamber (item 31). The fluid exits the chamber to the jeweled orifice (item 23, FIG. 3), which is sized to reduce the output stream in area and increase pressure. The output flow from the jeweled orifice impacts the radial turbine blade (item 19, FIG. 1) extracting the momentum from the flow, thereby causing the spindle shaft (item 3) to turn with high speed and great power. The fluid exits the turbine blades and flows radically through the circumferential annulus and then into the collection chamber (item 32). Here the fluid exits via drains (item 40, FIG. 7). Depending on the stiffness requirement for the particular system the discharged fluid may either feed the hydrostatic bearings, and/or provided for jet assist, or be returned for reuse.

In order to provide thrust-bearing capacity to the system, some of the inlet flow can flow across the small gap (item 21) between the land and the turbine wheel top face. This small gap may be on the order of 10-15 micrometers. The fluid enters a central drain pocket and then flows axially through the spindle shaft to the drain groove 15 where it is collected for discharge or returned to the main system. The other side of the thrust bearing which resists pull-out forces on the spindle shaft and acts to preload the rear thrust bearing is formed with an inlet resistance (item 22) formed by a radial gap on the order of 10 micrometers between the bore in the front housing item 1. The fluid flows axially in this radial gap to enter the thrust bearing pocket. Resistance to fluid flow to exit the thrust pocket is provided by an axial land and a radial land both of which may be in the order of 10 micrometers. The relative diameters of the thrust bearing faces must be sized to resist cutting thrust loads and thrust loads generated by different pressures across the turbine. This type of thrust bearing is of the type described in U.S. Pat. Nos. 4,493,610 (Iino), 4,915,510 (Arvidsson) and others. There are many other thrust bearing compensation systems that could be used.

### REFERENCES

| | |
|---|---|
| 2,449,297 | Hoffer |
| 3,754,799 | Hedberg |
| 4,351,574 | Furukawa |
| 5,104,237 | Slocum |
| 4,493,610 | lino |
| 4,915,510 | Arvidsson |

What is claimed is:

1. A principal object of this invention is to provide a new and improved spindle system for cutting material including composites, aluminum and titanium utilizing ultra high-pressure water to solve limitations with the current art. The utilization of ultra high pressure water with an integrated bearing system significantly improves system stiffness, reduces the mass of the system and increase the material removal rates as a result of very high speed operation.

2. An additional object of this invention is to provide a radial flow turbine for the spindle shaft. The turbine may either be modular or integral to the rotating shaft. The turbine would be so arraigned such that the tool is directly driven by the ultra high-pressure fluid source acting on the turbine elements.

3. Still further object of this invention is to utilize turbine discharge water for the hydrostatic bearing contained within the system.

4. Further object of this invention is to incorporate in the spindle shaft a radial feed hole such that fluid exiting the system feeds to the tool center and then passes axially along the tool center supply additional force for improved chip removal.

5. A modular spindle system as claimed in claim 1 and in which the hydrostatic bearing grooves are radially and axially displaced along the shaft and thus are further provided annuli and drain ports for receiving the fluid from the bearing grooves.

6. An improved spindle system as claimed in claim 5 and in which there is a means of injecting Ultra High Pressure water acting as a jet along the axis of the spindle shaft improving chip removal.

7. A means to control Off/On Ultra High Pressure water flow at the spindle.
